(19) United States
(12) Patent Application Publication
(10) Pub. No.: US 2022/0189299 A1
(43) Pub. Date: Jun. 16, 2022

(54) Portable Traffic Light Assembly

(71) Applicant: Kydd Joseph, Baytown, TX (US)

(72) Inventor: Kydd Joseph, Baytown, TX (US)

(21) Appl. No.: 17/123,767

(22) Filed: Dec. 16, 2020

(51) Int. Cl. G08G 1/0955; G08G 1/07

(52) U.S. Cl. CPC G08G 1/0955; G08G 1/07

(57) ABSTRACT

A portable traffic light assembly includes a traffic sign that is manipulated by a person directing traffic. A plurality of lenses is each coupled to the traffic sign and each of the lenses has indicia printed thereon. A plurality of light emitters is each coupled to the traffic sign to emit light outwardly therefrom. Each of the light emitters is positioned behind a respective one of the lenses to enhance visibility of the respective lenses when the light emitters are turned on. A pole is coupled to the traffic sign and a plurality of control buttons is each movably coupled to the pole. Each of the control buttons turns a respective light emitter on and off. In this way the light emitters can be individually turned on for directing traffic.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to traffic light devices and more particularly pertains to a new traffic light device for facilitating a person to direct traffic without using hand signals.

### (2) Description of Related Art Including Information Disclosed Under 37 CFR 1.97 and 1.98

The prior art relates to traffic light devices including a variety of traffic signs that each has a plurality of light emitters being strategically arranged such that the plurality of light emitters can spell a variety of words for directing traffic. The prior art also discloses a variety of illuminated traffic signs to facilitate a person to direct traffic.

### BRIEF SUMMARY OF THE INVENTION

An embodiment of the disclosure meets the needs presented above by generally comprising a traffic sign that is manipulated by a person directing traffic. A plurality of lenses is each coupled to the traffic sign and each of the lenses has indicia printed thereon. A plurality of light emitters is each coupled to the traffic sign to emit light outwardly therefrom. Each of the light emitters is positioned behind a respective one of the lenses to enhance visibility of the respective lenses when the light emitters are turned on. A pole is coupled to the traffic sign and a plurality of control buttons is each movably coupled to the pole. Each of the control buttons turns a respective light emitter on and off. In this way the light emitters can be individually turned on for directing traffic.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a portable traffic light assembly according to an embodiment of the disclosure.

FIG. 2 is a front exploded view of an embodiment of the disclosure.

FIG. 3 is a left side view of an embodiment of the disclosure.

FIG. 4 is a back phantom view of an embodiment of the disclosure.

FIG. 5 is a schematic view of an embodiment of the disclosure.

### DETAILED DESCRIPTION OF THE INVENTION

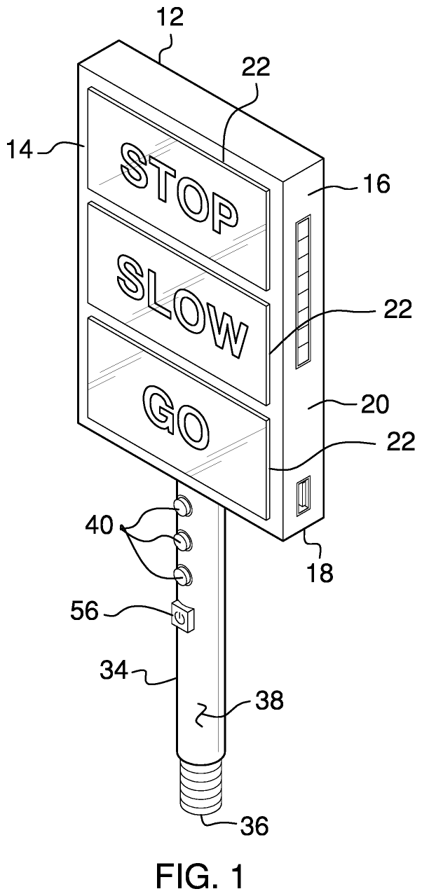

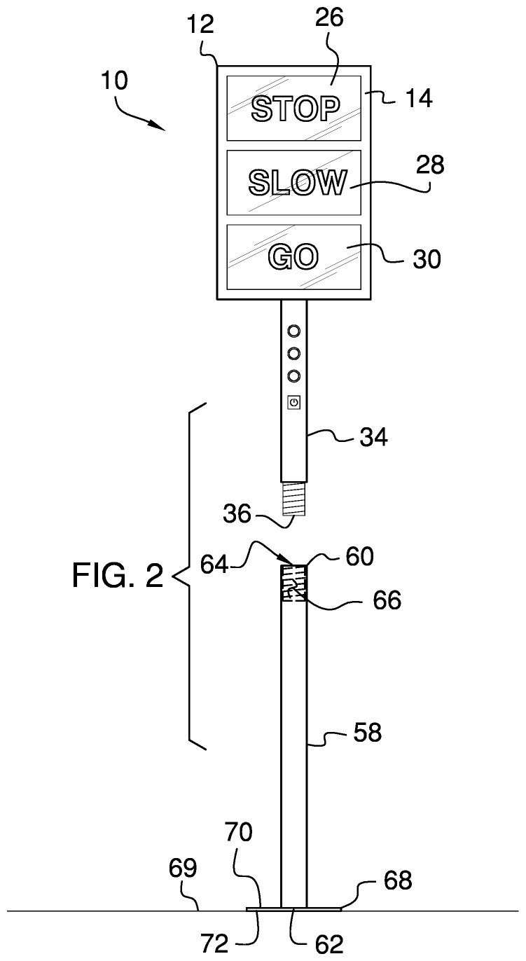

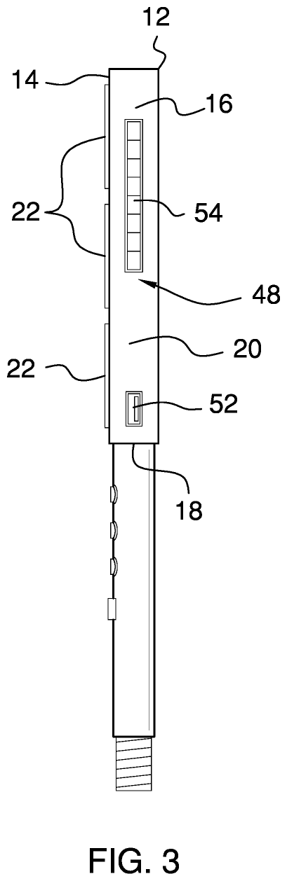

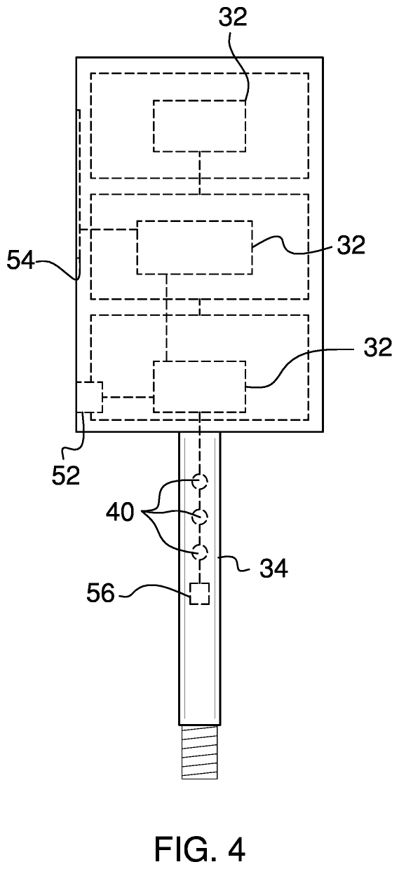

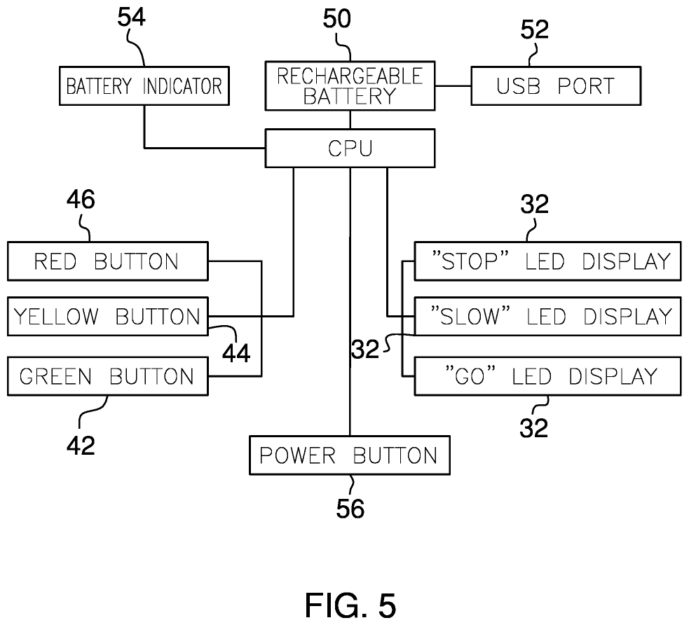

With reference now to the drawings, and in particular to FIGS. 1 through 5 thereof, a new traffic sign device embodying the principles and concepts of an embodiment of the disclosure and generally designated by the reference numeral 10 will be described.

As best illustrated in FIGS. 1 through 5, the portable traffic light assembly 10 generally comprises a traffic sign 12 that is manipulated by a person directing traffic such that the traffic sign 12 is visible to the traffic. The traffic sign 12 has a front face 14 and a perimeter face 16, and the perimeter face 16 has a bottom side 18 and a first lateral side 20. A plurality of lenses 22 is each coupled to the traffic sign 12 and each of the lenses 22 has indicia 24 printed thereon. The lenses 22 are spaced apart from each other and are vertically distributed on the traffic sign 12.

The plurality of lenses 22 includes a stop lens 26, a slow lens 28 and a go lens 30. The indicia 24 on the stop lens 26 comprise the word “stop”, the indicia 24 on the slow lens 28 comprise the word “slow”, and the indicia 24 on the go lens 30 comprise the word “go”. Each of the lenses 22 is comprised of a translucent material to pass light therethrough and each of the lenses 22 has a distinct color with respect to each other. The stop lens 26 may have a red color, the slow lens 28 may have an amber color and the go lens 30 may have a green color. A plurality of light emitters 32 is each of coupled to the traffic sign 12 to emit light outwardly therefrom. Each of the light emitters 32 is positioned behind a respective one of the lenses 22 to enhance visibility of the respective lenses 22 when the light emitters 32 are turned on. Each of the light emitters 32 may comprise an LED or other type of electronic light emitter.

A pole 34 is coupled to the traffic sign 12 and the pole 34 can be gripped by the person directing traffic. The pole 34 extends away from the bottom side 18 of the peripheral face of the traffic sign 12. The pole 34 has a distal end 36 with respect to the bottom side 18 and an outer surface 38 of the pole 34 is threaded adjacent to the distal end 36. A plurality of control buttons 40 is each movably coupled to the pole 34. Each of the control buttons 40 is in electrical communication with a respective one of the light emitters 32 for turning the respective light emitter on and off. The plurality of control buttons 40 includes a go button 42, a slow button 44 and a stop button 46. The go button 42 is associated with the light emitter 32 behind the go lens 30, the slow button 44 is associated with the light emitter 32 behind the slow lens 28 and the stop button 46 is associated with the light emitter 32 behind the stop lens 26.

A power supply 48 is integrated into the traffic sign 12 and the power supply 48 is electrically coupled to each of the plurality of light emitters 32. The power supply 48 comprises at least one battery 50 that is positioned in the traffic sign 12 and the at least one battery 50 is electrically coupled to each of the control buttons 40. The power supply 48 includes a charge port 52 that is recessed into the traffic sign 12 to engage a power cord from a charger. The charge port 52 is electrically coupled to the at least one battery 50 for charging the at least one battery 50 and the charge port 52 may be positioned on the first lateral side 20 of the perimeter face 16 of the traffic sign 12

The power supply 48 includes a power indicator 54 that is coupled to the traffic sign 12. The power indicator 54 is electrically coupled to the at least one battery 50 and the power indicator 54 indicates a charge level of the at least one battery 50. The power indicator 54 may be positioned on the first lateral side 20 of the perimeter face 16 of the traffic sign 12. Additionally, the power supply 48 includes a power button 56 that is movably coupled to the pole 34 and the power button 56 is electrically coupled to the at least one battery 50. The power button 56 disables each of the light emitters 32 when the power button 56 is turned off and the power button 56 enables each of the light emitters 32 when the power button 56 is turned on.

A rod 58 is provided and the rod 58 is removably attachable to the pole 34 for standing the traffic sign 12 in an upright orientation thereby enhancing visibility of the traffic sign 12 with respect to traffic. The rod 58 has an upper end 60 and a lower end 62, and the upper end 60 has a well 64 extending toward the lower end 62. The well 64 has a bounding surface 66 and the well 64 insertably receives the distal end 36 of the pole 34 having the outer surface 38 of the pole 34 threadably engaging the bounding surface 66 of the well 64. A base 68 is provided and the base 68 is coupled to the rod 58 to support the rod 58 in a vertical orientation on a support surface 69. The base 68 has a top side 70 and a bottom side 72, and the top side 70 is coupled to the lower end 62 of the rod 58. In this way the bottom side 72 of the base 68 abuts the support surface 69.

In use, the rod 58 is threaded onto the pole 34 and the power button 56 is depressed to enable the light emitters 32. The stop button 46 is depressed to illuminate the stop lens 26 thereby directing traffic to stop. The slow button 44 is depressed to illuminate the slow lens 28 thereby directing traffic to slow down. The go button 42 is depressed to illuminate the go lens 30 thereby directing traffic to go. In this way the person directing traffic can direct traffic without using hand signals that might be misinterpreted by traffic. Additionally, the traffic sign 12 can be stood upright on the rod 58 to enhance comfort for the person directing traffic.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A portable traffic light assembly for facilitating a person to effectively direct traffic with standard traffic signals, said assembly comprising:
a traffic sign being manipulated by a person directing traffic wherein said traffic sign is configured to be visible to the traffic, said traffic sign having a rectangular perimeter shape;
a plurality of lenses, each of said lenses being coupled to said traffic sign, each of said lenses having indicia being printed thereon, said lenses being spaced apart from each other and being vertically distributed on said traffic sign, wherein said plurality of lenses includes a stop lens, a slow lens and a go lens, said indicia on said stop lens comprising the word “stop”, said indicia on said slow lens comprising the word “slow”, said indicia on said go lens comprising the word “go”, said slow lens being positioned between said stop lens and said go lens, said indicia being oriented such that said stop lens is above said slow lens and said slow lens is above said go lens;
a plurality of light emitters, each of said light emitters being coupled to said traffic sign wherein each of said light emitters is configured to emit light outwardly therefrom, each of said light emitters being positioned behind a respective one of said lenses wherein each of said light emitters is configured to enhance visibility of said respective lenses when said light emitters are turned on;
a pole being coupled to said traffic sign wherein said pole is configured to be gripped by the person directing traffic;
a plurality of control buttons, each of said control buttons being coupled directly to said pole wherein each of said control buttons is configured to be manipulatable While the traffic sign is held, each of said control buttons being in electrical communication with a respective one of said light emitters for turning said respective light emitter on and off wherein said light emitters are configured to direct traffic;
a rod being removably attachable to said pole for standing said traffic sign in an upright orientation wherein said rod is configured to enhance visibility of said traffic sign with respect to traffic; and
a base being coupled to said rod wherein said base is configured to support said rod in a vertical orientation on a support surface.

2. (canceled)

3. The assembly according to claim 1, wherein:
each of said lenses is comprised of a translucent material wherein each of said lenses is configured to pass light therethrough; and
each of said lenses has a distinct color with respect to each other.

4. The assembly according to claim 1, wherein:
said traffic sign has a front face and a perimeter face, said perimeter face having a bottom side and a first lateral side; and
said pole extends away from said bottom side of said peripheral face of said traffic sign, said pole having a distal end with respect to said bottom side, an outer surface of said pole being threaded adjacent to said distal end.

5. The assembly according to claim 1, wherein said plurality of control buttons includes a go button, a slow button and a stop button, said go button being associated with said light emitter behind said go lens, said slow button being associated with said light emitter behind said slow lens, said stop button being associated with said light emitter behind said stop lens.

6. The assembly according to claim 1, further comprising a power supply being integrated into said traffic sign, said power supply being electrically coupled to each of said plurality of light emitters, said power supply comprising:
at least one battery being positioned in said traffic sign, said at least one battery being electrically coupled to each of said control buttons;
a charge port being recessed into said traffic sign wherein said charge port is configured to engage a power cord from a charger, said charge port being electrically coupled to said at least one battery for charging said at least one battery;
a power indicator being coupled to said traffic sign, said power indicator being electrically coupled to said at least one battery, said power indicator indicating a charge level of said at least one battery; and
a power button being movably coupled to said pole, said power button being electrically coupled to said at least one battery, said power button disabling each of said light emitters when said power button is turned off, said power button enabling each of said light emitters when said power button is turned on.

7. The assembly according to claim 4, wherein said rod has an upper end and a lower end, said upper end having a well extending toward said lower end, said well having a bounding surface, said well insertably receiving said distal end of said pole having said outer surface of said pole threadably engaging said bounding surface of said well.

8. The assembly according to claim 7, wherein said base has a top side and a bottom side, said top side being coupled to said lower end of said rod wherein said bottom side is configured to abut the support surface.

9. A portable traffic light assembly for facilitating a person to effectively direct traffic with standard traffic signals, said assembly comprising:
a traffic sign being manipulated by a person directing traffic wherein said traffic sign is configured to be visible to the traffic, said traffic sign having a front face and a perimeter face, said perimeter face having a bottom side and a first lateral side, said traffic sign having a rectangular perimeter shape;
a plurality of lenses, each of said lenses being coupled to said traffic sign, each of said lenses having indicia being printed thereon, said lenses being spaced apart from each other and being vertically distributed on said traffic sign, said plurality of lenses including a stop lens, a slow lens and a go lens, said indicia on said stop lens comprising the word “stop”, said indicia on said slow lens comprising the word “slow”, said indicia on said go lens comprising the word “go”, each of said lenses being comprised of a translucent material wherein each of said lenses is configured to pass light therethrough, each of said lenses having a distinct color with respect to each other, said slow lens being positioned between said stop lens and said go lens, said indicia being oriented such that said stop lens is above said slow lens and said slow lens is above said go lens;
a plurality of light emitters, each of said light emitters being coupled to said traffic sign wherein each of said light emitters is configured to emit light outwardly therefrom, each of said light emitters being positioned behind a respective one of said lenses wherein each of said light emitters is configured to enhance visibility of said respective lenses when said light emitters are turned on;
a pole being coupled to said traffic sign wherein said pole is configured to be gripped by the person directing traffic, said pole extending away from said bottom side of said peripheral face of said traffic sign, said pole having a distal end with respect to said bottom side, an outer surface of said pole being threaded adjacent to said distal end;
a plurality of control buttons, each of said control buttons being coupled directly to said pole wherein each of said control buttons is configured to be manipulatable while the traffic sign is held, each of said control buttons being in electrical communication with a respective one of said light emitters for turning said respective light emitter on and off wherein said plurality of light emitters is configured to direct traffic, said plurality of control buttons including a go button, a slow button and a stop button, said go button being associated with said light emitter behind said go lens, said slow button being associated with said light emitter behind said slow lens, said stop button being associated with said light emitter behind said stop lens;
a power supply being integrated into said traffic sign, said power supply being electrically coupled to each of said plurality of light emitters, said power supply comprising:
at least one battery being positioned in said traffic sign, said at least one battery being electrically coupled to each of said control buttons;
a charge port being recessed into said traffic sign wherein said charge port is configured to engage a power cord from a charger, said charge port being electrically coupled to said at least one battery for charging said at least one battery;
a power indicator being coupled to said traffic sign, said power indicator being electrically coupled to said at least one battery, said power indicator indicating a charge level of said at least one battery; and
a power button being movably coupled to said pole, said power button being electrically coupled to said at least one battery, said power button disabling each of said light emitters when said power button is turned off, said power button enabling each of said light emitters when said power button is turned on;
a rod being removably attachable to said pole for standing said traffic sign in an upright orientation wherein said rod is configured to enhance visibility of said traffic sign with respect to traffic, said rod having an upper end and a lower end, said upper end having a well extending toward said lower end, said well having a bounding surface, said well insertably receiving said distal end of said pole having said outer surface of said pole threadably engaging said bounding surface of said well; and
a base being coupled to said rod wherein said base is configured to support said rod in a vertical orientation on a support surface, said base having a top side and a bottom side, said top side being coupled to said lower end of said rod wherein said bottom side is configured to abut the support surface.
